(19) United States
(12) Patent Application Publication
(10) Pub. No.: US 2017/0091138 A1
(43) Pub. Date: Mar. 30, 2017

(54) CIRCUIT MODULE CAPABLE OF ESTABLISHING ONE OR MORE LINKS WITH ANOTHER DEVICE AND ASSOCIATED METHOD

(71) Applicant: Mediatek Inc., Hsin-Chu (TW)

(72) Inventor: Liang-Yen Wang, New Taipei City (TW)

(21) Appl. No.: 14/870,025

(22) Filed: Sep. 30, 2015

(51) Int. Cl. G06F 13/42; G06F 13/40

(52) U.S. Cl. CPC G06F 13/4282; G06F 13/4068

(57) ABSTRACT

A circuit module includes a physical layer, a first MAC layer, a second MAC layer and a multiplexer, where the physical layer is arranged to communicate with another device via a plurality of lanes, each lane represents a set of differential signal pairs, one pair for transmission and one pair for reception, and the multiplexer is coupled between the first MAC layer, the second MAC layer and the physical layer. In addition, the first MAC layer is coupled to a first group of the lanes via the physical layer, and selectively coupled to a second group of the lanes via the multiplexer and the physical layer; and the second MAC layer is selectively coupled to the second group of the lanes via the multiplexer and the physical layer.

### BACKGROUND

In the byte striping rule of the Peripheral Component Interconnect express (PCIe) specification, a packet is transmitted over a ×1, ×2, ×4, ×8, ×16 or ×32 link. Therefore, if the port implements a plurality of lanes and any one of the lanes has an abnormal link, it will cause a huge bandwidth loss. For example, in a case that a device uses four lanes (×4) to transmit/receive data, if the third lane is inactive, only the first lane and second lane can be used to transmit/receive data (×2), and the both the third lane and the fourth lane will not allowed to be used even if the fourth lane is active, causing huge bandwidth loss.

### SUMMARY

It is therefore an objective of the present invention to provide a circuit module capable of establishing one or more links with another device and associated method, which can effectively use the active lane, to solve the above-mentioned problem.

According to one embodiment of the present invention, a circuit module comprises a physical layer, a first MAC layer, a second MAC layer and a multiplexer, where the physical layer is arranged to communicate with another device via a plurality of lanes, each lane represents a set of differential signal pairs, one pair for transmission and one pair for reception, and the multiplexer is coupled between the first MAC layer, the second MAC layer and the physical layer. In addition, the first MAC layer is coupled to a first group of the lanes via the physical layer, and selectively coupled to a second group of the lanes via the multiplexer and the physical layer; and the second MAC layer is selectively coupled to the second group of the lanes via the multiplexer and the physical layer.

According to another embodiment of the present invention, a method for communicating with another device comprises: providing a physical layer, arranged to communicate with another device via a plurality of lanes, wherein each lane represents a set of differential signal pairs, one pair for transmission and one pair for reception; providing a first MAC layer and a second MAC layer; coupling the first MAC layer to a first group of the lanes via the physical layer; and selectively coupling the first MAC layer to a second group of the lanes via the physical layer, or selectively coupling the second MAC layer to the second group of the lanes via the physical layer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a circuit module according to one embodiment of the present invention.

FIG. 2 is a diagram showing the operations of the circuit module shown in FIG. 1 when all the lanes are active.

FIG. 3 is a diagram showing the operations of the circuit module shown in FIG. 1 when the lane_2 or lane_3 is inactive.

FIGS. 4A-4E are diagrams illustrating the flows of confirming the link and active lanes when one of the lanes is inactive according to one embodiment of the present invention.

FIG. 5 is a diagram illustrating a circuit module according to one embodiment of the present invention.

FIG. 6 is a flowchart of a method for communicating with another device according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” The terms “couple” and “couples” are intended to mean either an indirect or a direct electrical connection. Thus, if a first device couples to a second device, that connection may be through a direct electrical connection, or through an indirect electrical connection via other devices and connections.

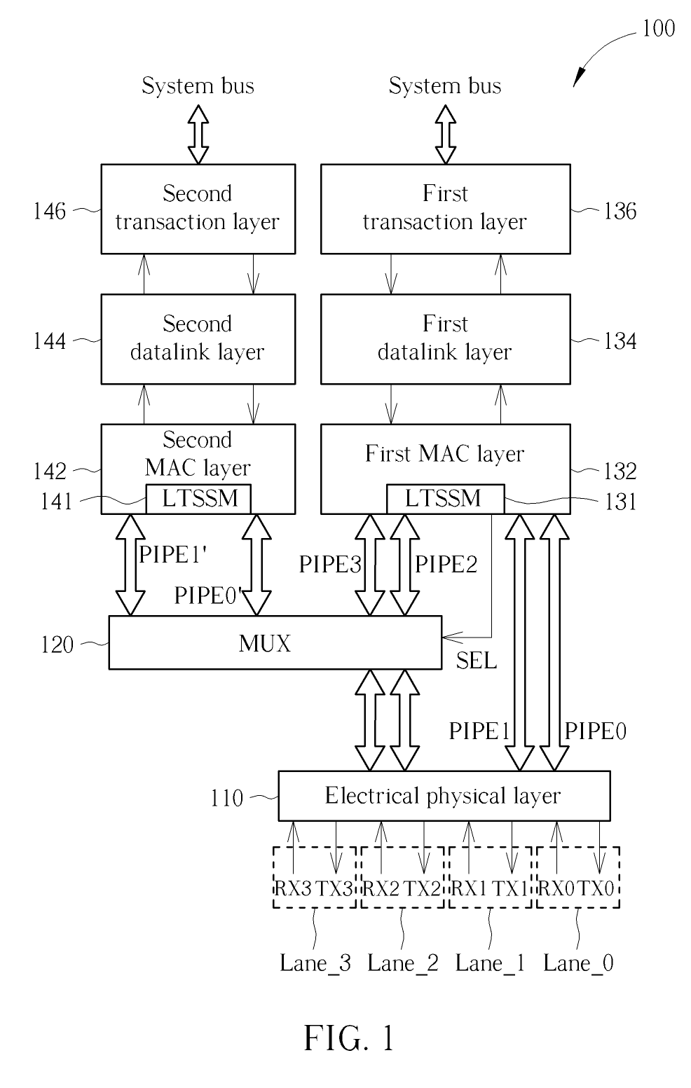

Please refer to FIG. 1, which is a diagram illustrating a circuit module 100 according to one embodiment of the present invention. As shown in FIG. 1, the circuit module 100 comprises an electrical physical layer 110, a multiplexer 120, a first media access (MAC) layer 132 comprising a link training and status state machine (LTSSM) 131, a first data link layer 134, a first transaction layer 136, a second MAC layer 142 comprising a LTSSM 141, a second data link layer 144 and a second transaction layer 146. In FIG. 1, the electrical physical layer 110 is arranged to communicate with another device via a plurality of lanes (in this embodiment, there are four lanes Lane_0-Lane_3), wherein each lane represents a set of differential signal pairs (e.g. TX0, RX0; TX1, RX1; TX2, RX2; TX3, RX3), and one pair for transmission and one pair for reception.

In this embodiment, the MAC layer 132 can communicate with the other device via the path PIPE0, electrical physical layer 110 and the lane Lane_0, and communicate with the other device via the path PIPE1, electrical physical layer 110 and the lane Lane_1. In addition, the multiplexer 120 is selectively couple one of the first MAC layer 132 and the second MAC layer 142 to the electrical physical layer 110, therefore, if the multiplexer 120 selects the first MAC layer 132, the first MAC layer 132 is allowed to communicate with the other device via the path PIPE2, multiplexer 120, electrical physical layer 110 and the lane Lane_2, and communicate with the other device via the path PIPE3, multiplexer 120, electrical physical layer 110 and the lane Lane_3; and if the multiplexer 120 selects the second MAC layer 142, the second MAC layer 142 is allowed to communicate with the other device via the path PIPE0′, multiplexer 120, electrical physical layer 110 and the lane Lane_2, and communicate with the other device via the path PIPE1′, multiplexer 120, electrical physical layer 110 and the lane Lane_3.

In this embodiment, the circuit module 100 is built in a chip, and is arranged to communicate with the other device, where the circuit module 100 and the other device can be positioned in the same chip, or in different chips.

The circuit module 100 complies with Peripheral Component Interconnect (PCI), PCI express (PCIe) or PCIe over MPHY (mPCIe, MPHY represents M-type PHY) standard, that is the transmission/reception needs to satisfy the byte striping rule, and a packet is transmitted over a ×1, ×2, ×4, ×8, ×16 or ×32 link. Therefore, to avoid the huge bandwidth loss due the inactive lane(s), the circuit module 100 is designed to have two MAC layers to build two links respectively to effectively use the remaining active lanes if one or more lanes are inactive.

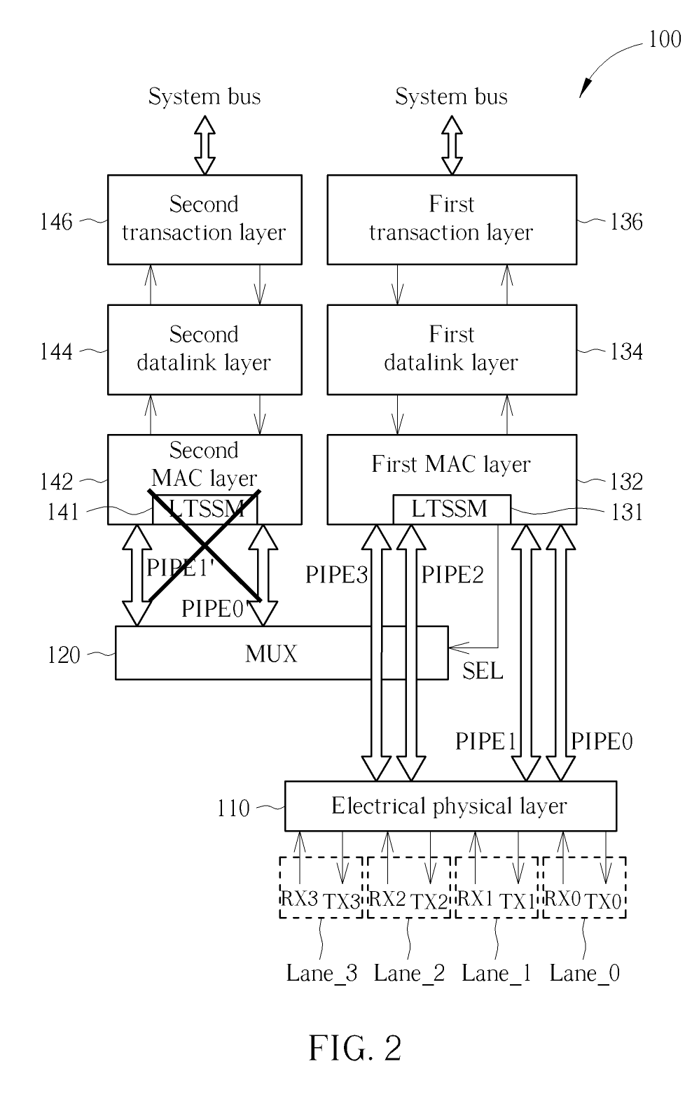

The LTSSM 131 is arranged to detecting whether the lanes are usable or active, and is arranged to build a link between the first MAC layer 132 and the other device. When the LTSSM 131 detects that all the lanes Lane_0-Lane_3 are active, the LTSSM 131 generates a control signal SEL to control the multiplexer 120 to couple the first MAC layer 132 to the electrical physical layer 110; and when the lane Lane_1 or Lane_3 is inactive, the LTSSM 131 generates the control signal SEL to control the multiplexer 120 to couple the second MAC layer 142 to the electrical physical layer 110. In detail, refer to FIG. 2, which is a diagram illustrating the operations of the circuit module 100 when all the lanes are active. As shown in FIG. 2, when all the lanes Lane_0-Lane_3 are active, the multiplexer 120 couples the first MAC layer 132 to the electrical physical layer 110, and the first MAC layer 132 can communicate with the other device via the paths PIPE0-PIPE3, electrical physical layer 110 and the lanes Lane_0-Lane_3, respectively. Meanwhile, the second MAC layer 142, the data link layer 144 and the second transaction layer 146 are disabled. In other words, when all the lanes Lane_0-Lane_3 are active, only one MAC layer (i.e. the first MAC layer 132) is enabled and used.

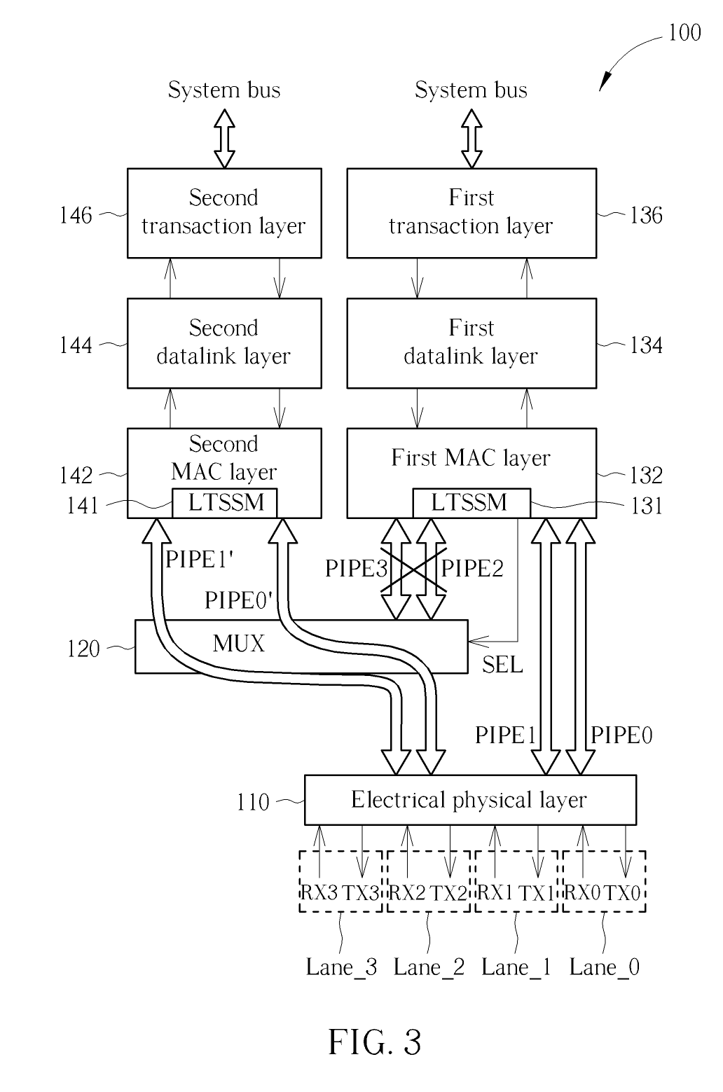

Refer to FIG. 3, which is a diagram illustrating the operations of the circuit module 100 when the lane Lane_2 or the lane Lane_3 is inactive. As shown in FIG. 3, when the lane Lane_3 is inactive, the multiplexer 120 couples the second MAC layer 142 to the lanes Lane_2 and Lane_3 via the electrical physical layer 110. At this time, the first MAC layer 132 still communicates with the other device via the paths PIPE0-PIPE1, electrical physical layer 110 and the lanes Lane_0-Lane_1, respectively; but the second MAC layer 142 builds another link with the other device, and the second MAC layer 142 communicates with the other device via the path PIPE0′, electrical physical layer 110 and the lane Lane_2. Comparing with the prior art technique that both the lanes Lane_2 and Lane_3 cannot be used if the lane Lane_3 is inactive, the embodiment of the present invention allows the lane Lane_2 to communicate with the other device via another link. Therefore, the bandwidth can be effectively used.

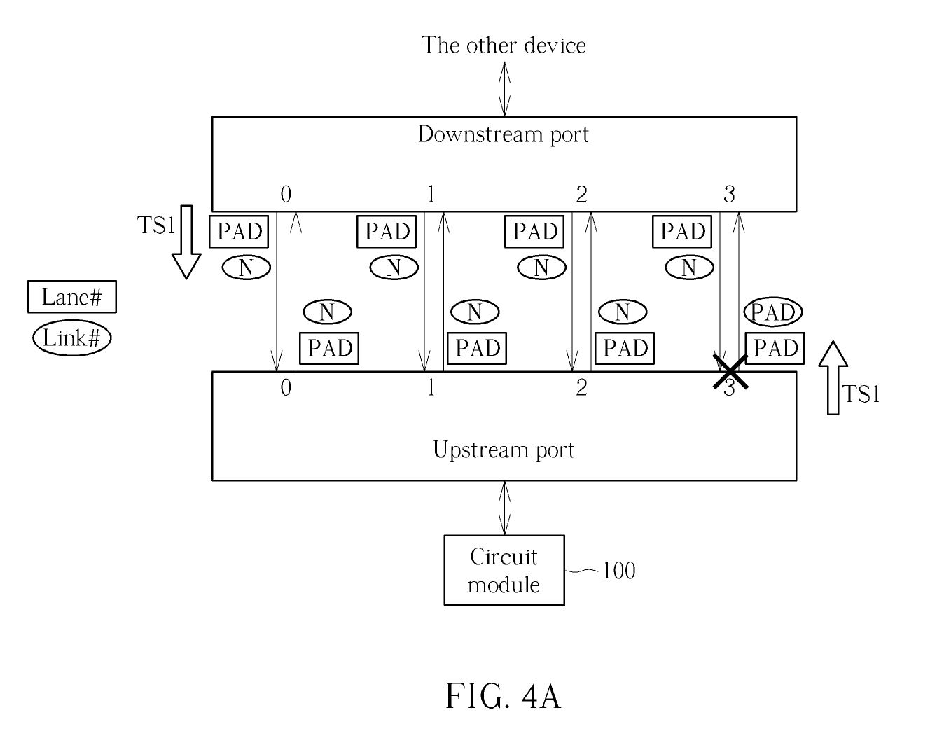

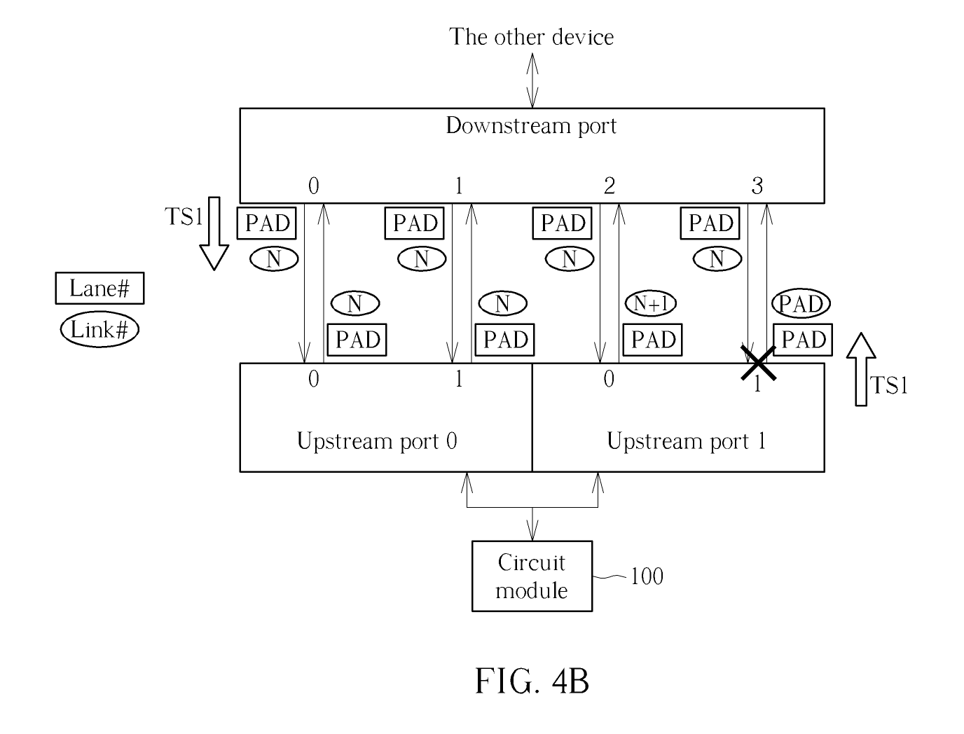

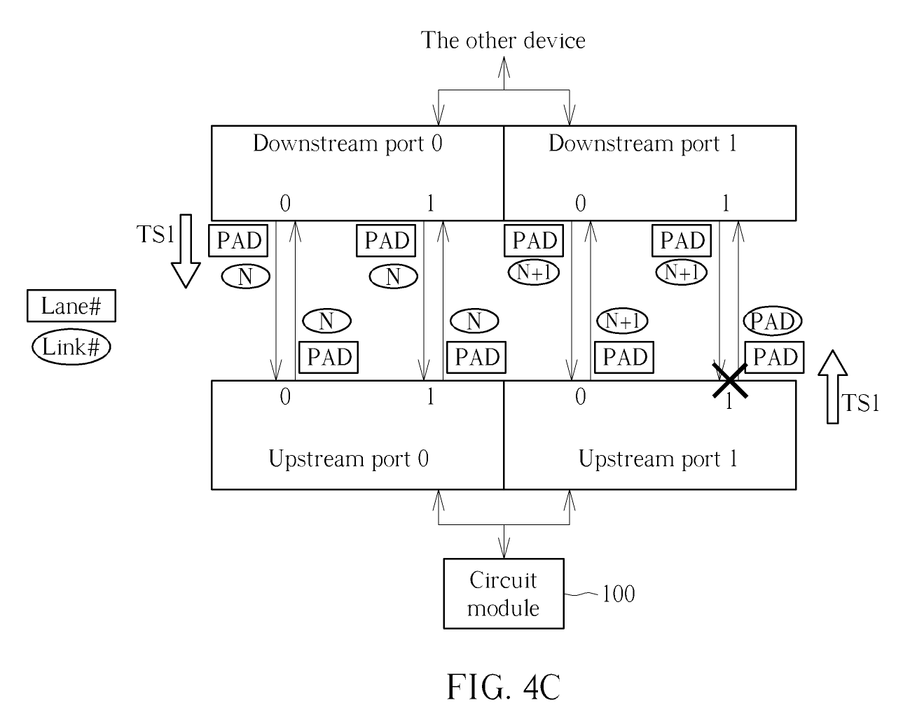

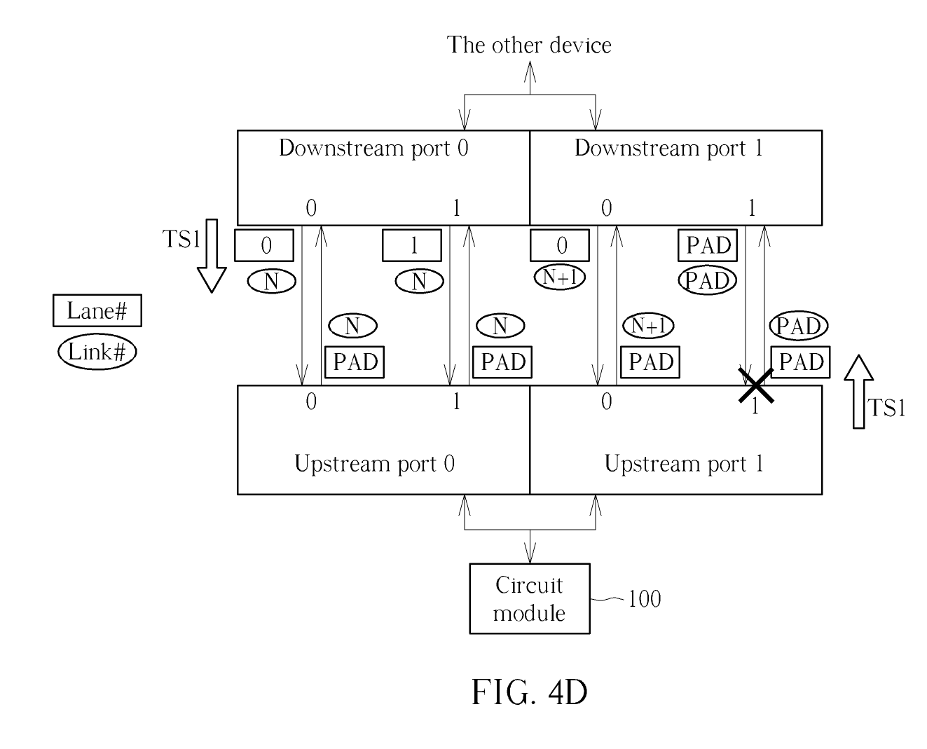

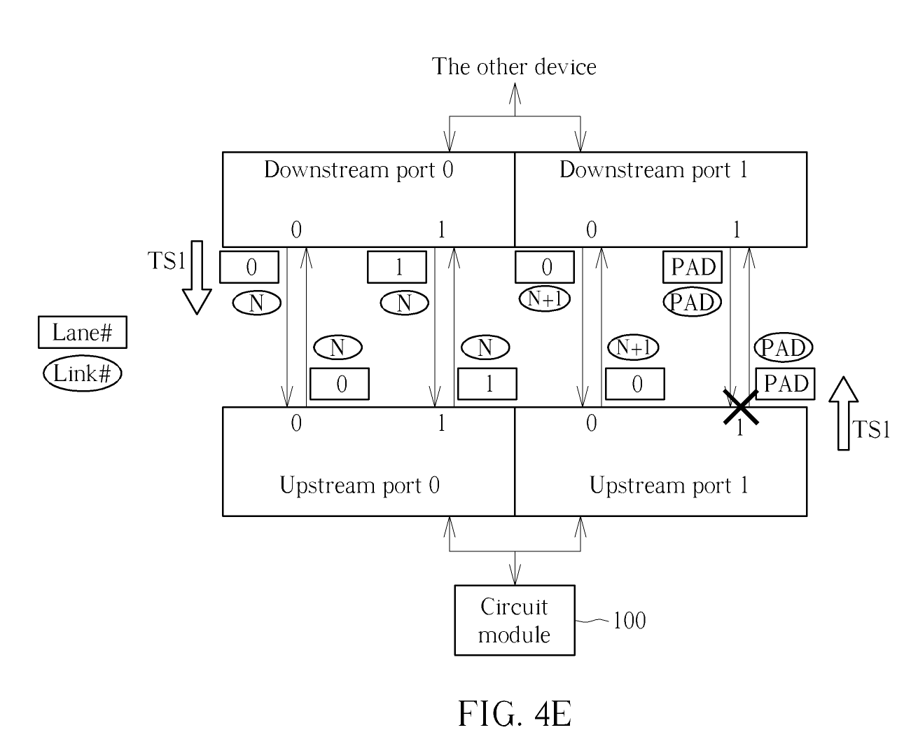

Please refer to FIGS. 4A-4E, which are diagrams illustrating the flows of confirming the link and active lanes when one of the lanes is inactive according to one embodiment of the present invention. In FIG. 4A, it is assumed that there are four lanes between the circuit module 100 and the other device, and the symbol “0”, “1”, “2”, “3” in the downstream port and upstream port correspond to the lanes Lane_0-Lane_3 shown in FIGS. 1-3, respectively. When the circuit module 100 starts to connect to the other device and there is no link between the circuit module 100 and the other device, the circuit module 100 and the other device may send the training sequence TS1 to each other, where the training sequence TS1 comprises at least a lane number and a link number. In detail, the other device may sends the lane number “PAD” and the link number “N” to the circuit module 100 via the downstream port, lanes and the upstream port, where “PAD” may be a symbol defined in the specification of PCIe. In addition, the circuit module 100 may respond the same lane number and link number to the other device. However, because the lane Lane_3 is inactive, the circuit module 100 and the other device may not receive the identified information for the lane Lane_3. Therefore, the circuit module 100 and the other device can determine that the lane Lane_3 is inactive.

In FIG. 4B, because the lane Lane_3 is inactive, the LTSSM 131 shown in FIG. 3 controls the multiplexer 120 to couple the second MAC layer 142 to the lanes Lane_2-Lane_3, and the other device communicates with two MAC layers of the circuit module, that is there are two upstream ports on the circuit module 100 side, where the upstream port 0 corresponds to the first MAC layer 132, and the upstream port 1 corresponds to the second MAC layer 142. At this time, the other device still sends the lane number “PAD” and the link number “N” to the circuit module 100 via the downstream port, lanes and the upstream ports. After receiving the lane numbers and link numbers from the other device, the first MAC layer 132 responds the lane number “PAD” and the link number “N” to the other device, but the second MAC layer 142 responds the link number “N+1” to the other device via the lane Lane_2.

In FIG. 4C, when the other device receives the link number “N+1” from the circuit module 100 via the lane Lane_2, the other device knows that the circuit module 100 wants to establish two links. Therefore, the other device may divide its downstream port into a downstream port 0 and a downstream port 1, where the downstream port 0 is arranged to communicate with the upstream port 0 via the lanes Lane_0-Lane_1, and the downstream port 1 is arranged to communicate with the upstream port 1 via the lanes Lane_2-Lane_3. Then, the other device sends the lane number “PAD” and the link number “N” to the circuit module 100 via the downstream port 0, and sends the lane number “PAD” and the link number “N+1” to the circuit module 100 via the downstream port 1. Then, the first MAC layer 132 responds the lane number “PAD” and the link number “N” to the other device to establish a first link, and the second MAC layer 142 responds the lane number “PAD” and the link number “N+1” to the other device via the lane Lane_2 to establish a second link, where the second link is independent from the first link.

In FIG. 4D, after establishing the first link and the second link, the other device sends the lane numbers to the circuit module 100 to confirm the lanes. In detail, the other device sends the lane number “0” to the circuit module 100 via the downstream port 0, lane Lane_0 and upstream port 0; the other device sends the lane number “1” to the circuit module 100 via the downstream port 0, lane Lane_1 and upstream port 0; and the other device sends the lane number “0” to the circuit module 100 via the downstream port 1, lane Lane_2 and upstream port 1. Then, in FIG. 4E, the circuit module 100 responds the lane number “0” to the other device via the upstream port 0, the lane Lane_0 and the downstream port 0; the circuit module 100 responds the lane number “1” to the other device via the upstream port 0, the lane Lane_1 and the downstream port 0; and the circuit module 100 responds the lane number “0” to the other device via the upstream port 1, the lane Lane_2 and the downstream port 1, to confirm the lanes.

After completing the steps shown in FIGS. 4A-4E, the circuit module 100 can communicate with the other device by using two links and three lanes, where the transmission/reception can satisfy the byte striping rule of PCIe specification (the MAC layer 132 uses x2 link, and the MAC layer 142 uses ×1 link). Therefore, the bandwidth can be effectively used.

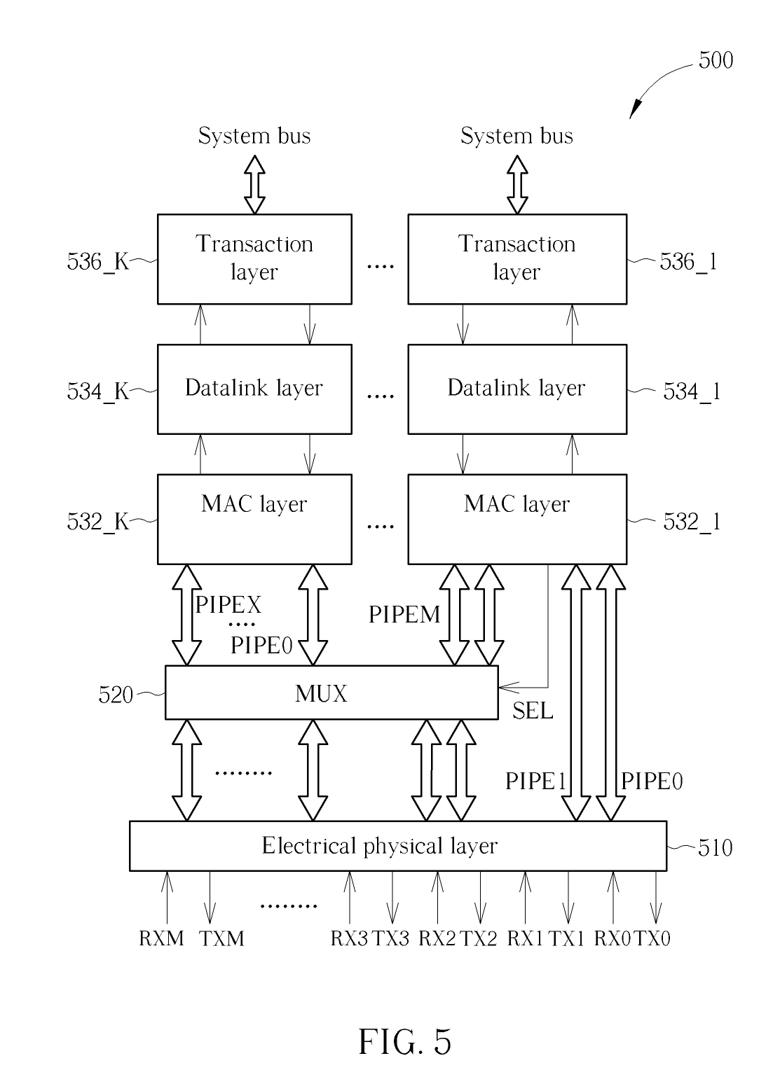

FIGS. 1-4E provides examples having two MAC layers and four lanes, however, in other embodiments of the present invention, the quantity of the MAC layers and quantity of the lanes can be modified by the designer's consideration. Refer to FIG. 5, which is a diagram illustrating a circuit module 500 according to another embodiment of the present invention. As shown in FIG. 5, the circuit module 500 comprises an electrical physical layer 510, a multiplexer 520, MAC layers 532_1-532_K, data link layers 534_1-534_K and transaction layers 536_1-536_K, where K can be any suitable values such as 2, 3 or 4. In FIG. 5, the electrical physical layer 510 is arranged to communicate with another device via a plurality of lanes (in this embodiment, there are M lanes), wherein each lane represents a set of differential signal pairs (e.g. TX0, RX0; TX1, RX1; . . . ; TXM, RXM), and one pair for transmission and one pair for reception. The multiplexer 520 is arranged to selectively couple one of the MAC layers to a portion of the lanes, for example, multiplexer 520 is arranged to select the MAC layer 532_K to (X+1) lanes.

The concept of the circuit module 500 is similar to that of the embodiment shown in FIG. 1, that is when the MAC layer 532_1 determines that one or more lanes are inactive. The MAC layer 532_1 may send a control signal SEL to control the multiplexer 520 to couple one or more other auxiliary MAC layers to a portion of lanes to build other link(s) with the other device, and effectively use the lanes that may not be used in a single link condition. Because a person skilled in the art should understand the operations of the circuit module 500 after reading the disclosure about the embodiments shown in FIGS. 1-4E, further descriptions are therefore omitted here.

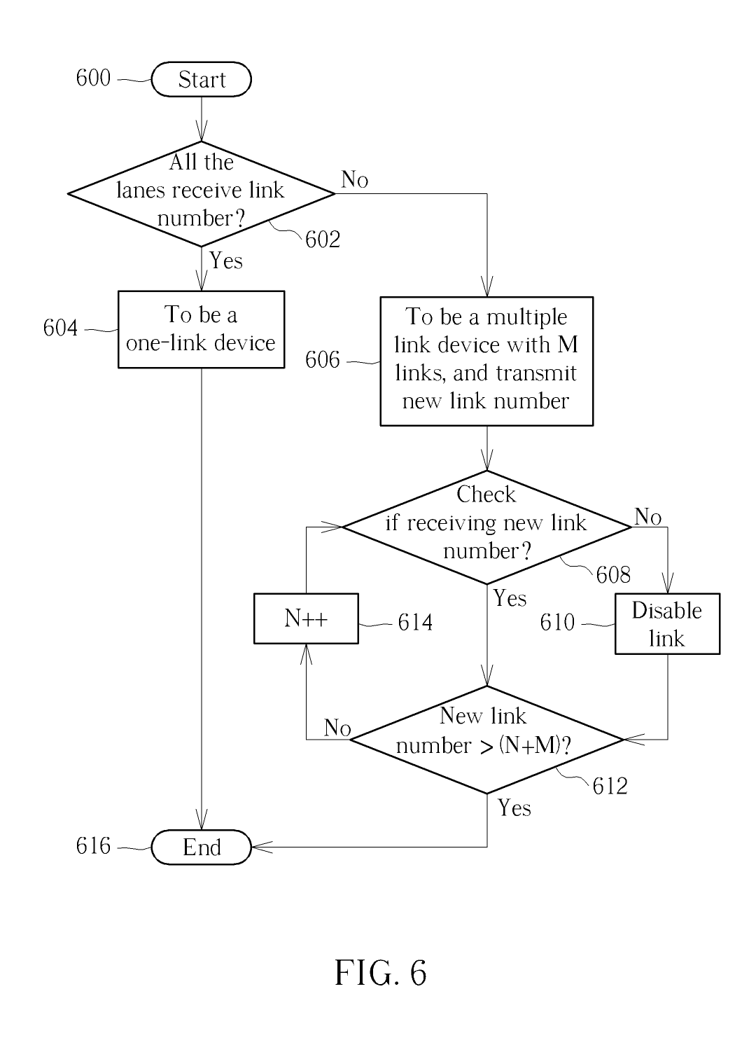

Please refer to FIG. 6, which is a flowchart of a method for communicating with another device according to one embodiment of the present invention. Referring to FIGS. 1-6, the flow is described as follows.

Step 600: the flow start.

Step 602: the circuit module 100/500 determines whether all the lanes receive the link number or not? If yes, the flow enters Step 604; and if not, the flow enters Step 606.

Step 604: the circuit module 100/500 operates as a one-link device.

Step 606: the circuit module 100/500 operates as a multiple link device with M links, and transmits new link number to the other device (e.g. the new link number “N+1” shown in FIG. 4B).

Step 608: the circuit module 100/500 checks if receiving the new link number from the other device? If yes, the flow enters Step 612; and if not, the flow enters Step 610.

Step 610. The circuit module 100/500 disables the link having this new link number.

Step 612: the circuit module 100/500 determines whether the new link number is greater than (N+M), where “N” is the link number of the first MAC layer 132/532_1. If yes, the flow enters Step 616; if not, the flow enters Step 614.

Step 614: the circuit module 100/500 increases the new link number by an increment of “1”, and transmits this updated new link number to the other device again. Then, the flow enters Step 608.

Step 616. The flow finishes.

Briefly summarized, in the present invention, when one of the lanes is inactive, the circuit module will establish two or more different links by using two or more MAC layers to effectively use the lanes. By using the techniques of the embodiments, the bandwidth can be effectively used, and the bandwidth loss can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A circuit module, comprising:
a physical layer, arranged to communicate with another device via a plurality of lanes, wherein each lane represents a transmission path and a reception path;
a first media access (MAC) layer;
a second MAC layer; and
a multiplexer, coupled between the first MAC layer, the second MAC layer and the physical layer;
wherein the first MAC layer is coupled to a first group of the lanes via the physical layer, selectively coupled to a second group of the lanes via the multiplexer and the physical layer; and the second MAC layer is selectively coupled to the second group of the lanes via the multiplexer and the physical layer.

2. The circuit module of claim 1, wherein when the first group and the second group of the lanes are all active, the multiplexer couples the first MAC layer to the physical layer and the second group of the lanes.

3. The circuit module of claim 2, wherein when the first group and the second group of the lanes are all active, the second MAC layer is disabled.

4. The circuit module of claim 1, wherein when the second group of the lanes has an inactive lane, the multiplexer couples the second MAC layer to the physical layer and the second group of the lanes.

5. The circuit module of claim 1, wherein when the first group and the second group of the lanes are all active, the transmission/reception of the first group and the second group of the lanes are under a single link; and when the second group of the lanes has an inactive lane, the transmission/reception of the first group and the second group of the lanes are under two different links.

6. The circuit module of claim 5, wherein when the second group of the lanes has the inactive lane, the first MAC layer establishes a first link with the another device via the first group of the lanes, and the second MAC layer establishes a second link with the another device via the second group of the lanes.

7. The circuit module of claim 6, wherein when the second group of the lanes has the inactive lane, and the second MAC layer receives a link number from the another device via an active lane of the second group, the second MAC layer responds another link number to the another device via the active lane of the second group.

8. The circuit module of claim 6, wherein when the second group of the lanes has the inactive lane, the first MAC layer and the second MAC layer receive a link number from the another device via the lanes, and the first MAC layer responds the same link number to the another device via the first group of the lanes, but the second MAC layer responds another link number to the another device via an active lane of the second group.

9. The circuit module of claim 8, wherein after the second MAC layer responds another link number to the another device via an active lane of the second group, if the second MAC layer receives the another link number from the another device, the second MAC layer responds the another link number to the another device again to confirm the second link.

10. The circuit module of claim 1, wherein the circuit module is complied with Peripheral Component Interconnect (PCI), PCI express (PCIe) or PCIe over MPHY (mPCIe) standard.

11. A method for communicating with another device, comprising:
providing a physical layer, arranged to communicate with another device via a plurality of lanes, wherein each lane represents a transmission path and a reception path;
providing a first media access (MAC) layer and a second MAC layer;
coupling the first MAC layer to a first group of the lanes via the physical layer; and
selectively coupling the first MAC layer to a second group of the lanes via the physical layer, or selectively coupling the second MAC layer to the second group of the lanes via the physical layer.

12. The method of claim 11, wherein the step of selectively coupling the first MAC layer to the second group of the lanes via the physical layer, or selectively coupling the second MAC layer to the second group of the lanes via the physical layer comprises:
when the first group and the second group of the lanes are all active, coupling the first MAC layer to the physical layer and the second group of the lanes.

13. The method of claim 12, further comprising:
when the first group and the second group of the lanes are all active, disabling the second MAC layer.

14. The method of claim 11, wherein the step of selectively coupling the first MAC layer to the second group of the lanes via the physical layer, or selectively coupling the second MAC layer to the second group of the lanes via the physical layer comprises:
when the second group of the lanes has an inactive lane, coupling the second MAC layer to the physical layer and the second group of the lanes.

15. The method of claim 11, further comprising:
when the first group and the second group of the lanes are all active, setting transmission/reception of the first group and the second group of the lanes to be processed under a single link; and
when the second group of the lanes has an inactive lane, setting transmission/reception of the first group and the second group of the lanes to be processed under two different links.

16. The method of claim 15, wherein the step of setting the transmission/reception of the first group and the second group of the lanes to be processed under two different links comprises:
using the first MAC layer to establish a first link with the another device via the first group of the lanes; and
using the second MAC layer to establish a second link with the another device via the second group of the lanes.

17. The method of claim 16, wherein the step of using the second MAC layer to establish the second link with the another device via the second group of the lanes comprises:
when the second MAC layer receives a link number from the another device via an active lane of the second group, responding another link number to the another device via the active lane of the second group.

18. The method of claim 16, wherein the step of setting the transmission/reception of the first group and the second group of the lanes to be processed under two different links comprises:
when the first MAC layer and the second MAC layer receive a link number from the another device via the lanes:
responding the same link number to the another device via the first group of the lanes by the first MAC layer; and
responding another link number to the another device via an active lane of the second group by the second MAC layer.

19. The method of claim 18, wherein the step of setting the transmission/reception of the first group and the second group of the lanes to be processed under two different links further comprises:
after responding another link number to the another device via an active lane of the second group by the second MAC layer, if the second MAC layer receives the another link number from the another device, responding the another link number to the another device again to confirm the second link.

20. The method of claim 11, wherein the method is complied with Peripheral Component Interconnect (PCI), PCI express (PCIe) or mini PCIe (mPCIe) standard.
